(19) United States
(12) Patent Application Publication
(10) Pub. No.: US 2011/0055441 A1
(43) Pub. Date: Mar. 3, 2011

(54) DATA COMPRESSION AND DECOMPRESSION APPARATUS AND DATA COMPRESSION AND DECOMPRESSION METHOD

(75) Inventor: Masato UCHIYAMA, Kawasaki-shi (JP)

(73) Assignee: KABUSHIKI KAISHA TOSHIBA, Tokyo (JP)

(21) Appl. No.: 12/752,850

(22) Filed: Apr. 1, 2010

(30) Foreign Application Priority Data
Aug. 26, 2009 (JP) 2009-195668

(51) Int. Cl. G06F 13/38

(52) U.S. Cl. 710/68

(57) ABSTRACT

A data compression and decompression apparatus according to an embodiment of the present invention comprises: a plurality of compression modules that implements compression algorithms with the same compression rate and different throughputs, respectively, a plurality of decompression modules that implements decompression algorithms corresponding to the compression algorithms of the compression modules, respectively, and an algorithm switching unit that switches a compression module to be used for compression of the write data and a decompression module to be used for decompression of the compressed data according to a progress of data processing in the data processing module.

### CROSS-REFERENCE TO RELATED APPLICATIONS

This application is based upon and claims the benefit of priority from the prior Japanese Patent Application No. 2009-195668, filed on Aug. 26, 2009; the entire contents of which are incorporated herein by reference.

### BACKGROUND OF THE INVENTION

1. Field of the Invention

The present invention relates to a data compression and decompression apparatus and a data compression and decompression method.

2. Description of the Related Art

Conventionally, a compression and decompression algorithm is known which sequentially performs compression and decompression on image data pixel by pixel (e.g., uncompressed 8-bit data) by utilizing correlation with pixels before and after a pixel regardless of a fixed length and a variable length. The processing is sequential in such an algorithm, so that only one pixel is subjected to the compression and decompression processing in one cycle in most cases.

On the contrary, throughput of most buses is a plurality of pixels in one cycle.

When the compression and decompression algorithm for sequentially performing the compression and decompression is used in an interface (I/F) portion of a bus in a chip, other accesses may be kept waiting depending on the number of cycles required for the compression or the decompression, and the latency in the compression and decompression may limit the process performance of a whole image processing system depending on the degree of margin in the number of cycles in the processing in the data processing module.

On the other hand, a compression and decompression algorithm that uses fixed-length coding and does not utilize correlation with pixels before and after a pixel can perform the compression and decompression on a plurality of pixels in parallel, so that high compression and decompression throughput similar to the throughput of a bus can be easily realized. However, because the compression efficiency is low compared with the case of utilizing correlation with pixels before and after a pixel, more compression loss occurs at the same compression rate.

Moreover, when a memory size is determined on the premise of a specific compression rate, the compression processing at this compression rate is inevitable, so that there is no choice of avoiding performing the compression processing itself and lowering the compression rate for improving the throughput. Therefore, a method of selectively switching whether to perform the compression processing depending on the congestion degree, which is disclosed, for example, in Japanese Patent Application Laid-open No. 2006-293694, cannot be applied.

### BRIEF SUMMARY OF THE INVENTION

A data compression and decompression apparatus that compresses write data input from a data processing module and stores it in an external memory, and decompresses compressed data read out from the external memory and outputs it to the data processing module according to an embodiment of the present invention comprises: a plurality of compression modules that implements compression algorithms with same compression rate and different throughputs, respectively;

a plurality of decompression modules that implements decompression algorithms corresponding to the compression algorithms of the compression modules, respectively; and

an algorithm switching unit that switches a compression module to be used for compression of the write data and a decompression module to be used for decompression of the compressed data according to a progress of data processing in the data processing module.

Moreover, a data compression and decompression method of compressing write data input from a data processing module and storing it in an external memory, and decompressing compressed data read out from the external memory and outputting it to the data processing module according to an embodiment of the present invention comprises:

switching a compression module to be used for compression of the write data and a decompression module to be used for decompression of the compressed data between a plurality of compression modules that implements compression algorithms with same compression rate and different throughputs and a plurality of decompression modules that implements decompression algorithms corresponding to the compression algorithms of the compression modules, respectively, according to a progress of data processing in the data processing module.

### BRIEF DESCRIPTION OF THE DRAWINGS

FIG. 1 is a diagram illustrating a configuration of a data compression and decompression apparatus according to a first embodiment of the present invention;

FIG. 2 is a diagram illustrating a configuration of a conventional data compression and decompression apparatus;

FIG. 3 is a diagram illustrating an example of compressed data by using variable-length coding and compressed data by using fixed-length coding;

FIG. 4 is a diagram illustrating an example of a configuration of an algorithm selecting circuit;

FIG. 5 is a diagram illustrating an example of a change in the number of processing cycles and an update of a selection signal;

FIG. 6 is a diagram illustrating a configuration of a data compression and decompression apparatus according to a second embodiment of the present invention;

FIG. 7 is a diagram illustrating a configuration of a data compression and decompression apparatus according to a third embodiment of the present invention;

FIG. 8 is a diagram illustrating a state where an upper threshold and a lower threshold are set between respective two adjacent elements in an order of compression and decompression algorithms based on throughput; and

FIG. 9 is a diagram illustrating an example of a change in the number of the processing cycles and an update of the selection signal in a configuration in which three compression and decompression algorithms are switched.

### DETAILED DESCRIPTION OF THE INVENTION

Exemplary embodiments of data compression and decompression apparatus and a data compression and decompression method according to the present invention will be explained below in detail with reference to the accompanying drawings. The present invention is not limited to the following embodiments.

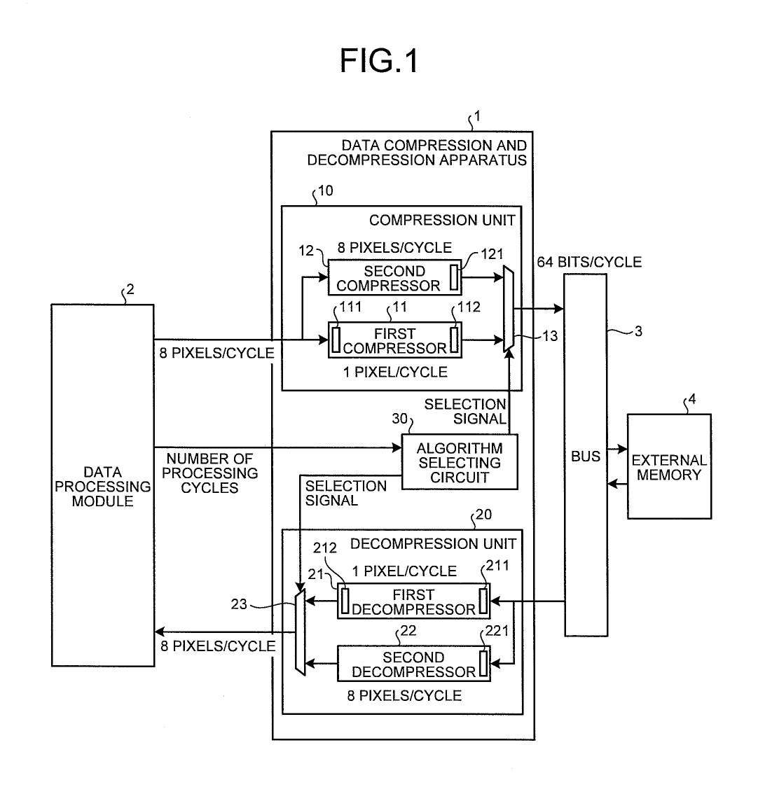

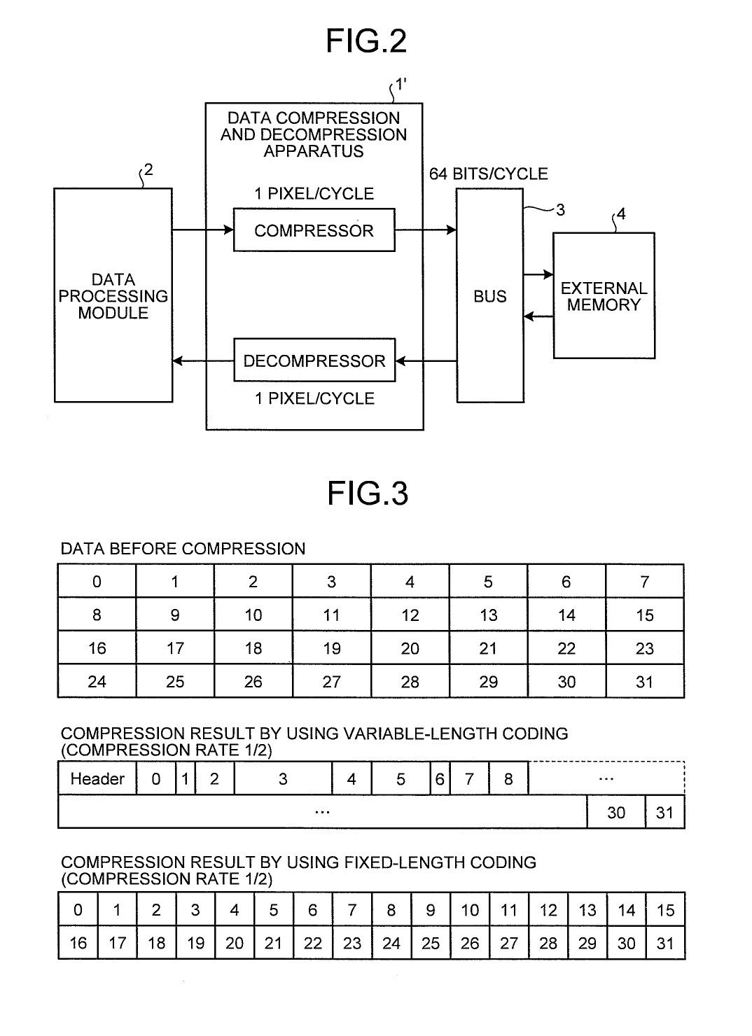

FIG. 1 is a diagram illustrating a configuration of a data compression and decompression apparatus according to a first embodiment of the present invention. A configuration of a conventional data compression and decompression apparatus is shown in FIG. 2 for comparison. A data compression and decompression apparatus 1 according to the present embodiment is similar to a conventional data compression and decompression apparatus 1′ in a point that the data compression and decompression apparatus 1 is connected to a data processing module 2 and a bus 3 and is further connected to an external memory 4 via the bus 3 to be applied to an image processing system. The data compression and decompression apparatus 1 is different from the conventional data compression and decompression apparatus 1′ in points that two compressors 11 and 12 and a selector 13 constitute a compression unit 10 and two decompressors 21 and 22 and a selector 23 constitute a decompression unit 20, and an algorithm selecting circuit 30 is included.

The compression unit 10 includes the first compressor 11, the second compressor 12, and the selector 13.

The first compressor 11 is a compression module that implements a compression algorithm by variable-length coding utilizing correlation with adjacent pixels, and a predetermined compression rate common to the second compressor 12 is set therein. In the first compressor 11, the compression loss is small (image degradation is small) compared with the second compressor 12; however, a compression throughput is as low as 1 pixel/cycle because data needs to be processed sequentially pixel by pixel. The first compressor 11 accumulates input data for eight pixels input from the data processing module 2 in a write data input buffer 111 and retrieves the input data pixel by pixel for processing them in order. In other words, the compression throughput of the first compressor 11 is ⅛ processing throughput compared with 8 pixels/cycle that is the output throughput of the data processing module 2, so that the output of the data processing module 2 is kept waiting in some cases. The first compressor 11 accumulates the compressed data in a compressed data output buffer 112, and outputs one piece of data to the selector 13 when the compressed data becomes 64 bits. When performing the compression by the variable-length coding, the first compressor 11 adds a header referred to at the time of the decompression in units of data block.

The second compressor 12 is a compression module that implements a compression algorithm for compressing into a fixed length independently from other pixels, and the predetermined compression rate common to the first compressor 11 is set therein. In the second compressor 12, the compression loss is large (image degradation is large) compared with the first compressor 11; however, the compression throughput is as high as 8 pixels/cycle because a plurality of pixels can be processed simultaneously. In other words, the second compressor 12 easily realizes a high throughput by implementing the compression algorithm using fixed-length coding. The second compressor 12 processes input data for eight pixels input from the data processing module 2 in parallel. In other words, the compression throughput of the second compressor 12 is equal to the output throughput of the data processing module 2, so that the output of the data processing module 2 is not kept waiting. The second compressor 12 accumulates the compressed data in a compressed data output buffer 121, and outputs one piece of data to the selector 13 when the compressed data becomes 64 bits. A bit length of the compressed data is a fixed length and is determined based on the compression rate. The bit length is known on the side of the decompression unit 20. Therefore, in the compression processing in the second compressor 12, a header does not need to be added.

The decompression unit 20 includes the first decompressor 21, the second decompressor 22, and the selector 23.

The first decompressor 21 includes a decompression algorithm corresponding to the compression algorithm of the first compressor 11 and performs the decompression processing with the decompression throughput of 1 pixel/cycle. The first decompressor 21 accumulates the input data of 64 bits input from the bus 3 in a compressed data input buffer 211 and retrieves the input data pixel by pixel for processing them in order. The first decompressor 21 accumulates the decompressed data in a decompressed data output buffer 212, and outputs one piece of data to the data processing module 2 when the decompressed data becomes data for eight pixels.

The second decompressor 22 includes a decompression algorithm corresponding to the compression algorithm of the second compressor 12 and performs the decompression processing with the decompression throughput of 8 pixels/cycle. The second decompressor 22 accumulates the input data of 64 bits input from the bus 3 in a compressed data input buffer 221 and retrieves the input data by eight pixels for processing. The decompression throughput and the transfer throughput to the data processing module 2 are the same, so that the second decompressor 22 outputs the decompressed data obtained by performing the decompression processing directly to the data processing module 2.

Explanation for the compression algorithm using the variable-length coding and the compression algorithm using the fixed-length coding is supplemented with a data block of 8×4 pixels as an example. As shown in FIG. 3, in the case of the compression algorithm using the variable-length coding, in the compressed data, the bit length becomes ½ of the data before compression as the whole data block; however, the bit length of the compressed data on each pixel is not constant. Therefore, for decompressing the compressed data compressed by the variable-length coding, information indicating the correspondence relationship between original data and a code is needed to specify a pixel separation. Thus, the first compressor 11 adds the information needed for specifying the correspondence between the original data and the code to the compressed data as the header, and the first decompressor 21 performs the decompression processing by referring to the header.

On the other hand, in the case of the compression algorithm using the fixed-length coding, in the compressed data, the bit length becomes ½ of the data before compression as the whole data block and also as each pixel, and the bit length of the compressed data of each pixel is constant. Therefore, in the case of the compression algorithm using the fixed-length coding, if the compression rate is known, the pixel separation in the compressed data can be specified. Thus, the second compressor 12 does not add the header to the compressed data in the compression processing, and the second decompressor 22 performs the decompression processing by specifying the pixel separation without referring to the header.

The memory size of the external memory 4 is set based on the compression rate in the compression processing in the first and second compressors 11 and 12.

The data processing module 2 performs moving image processing, and outputs, when the processing for one frame is completed, the number of cycles (the number of processing cycles) required for processing the frame to the algorithm selecting circuit 30.

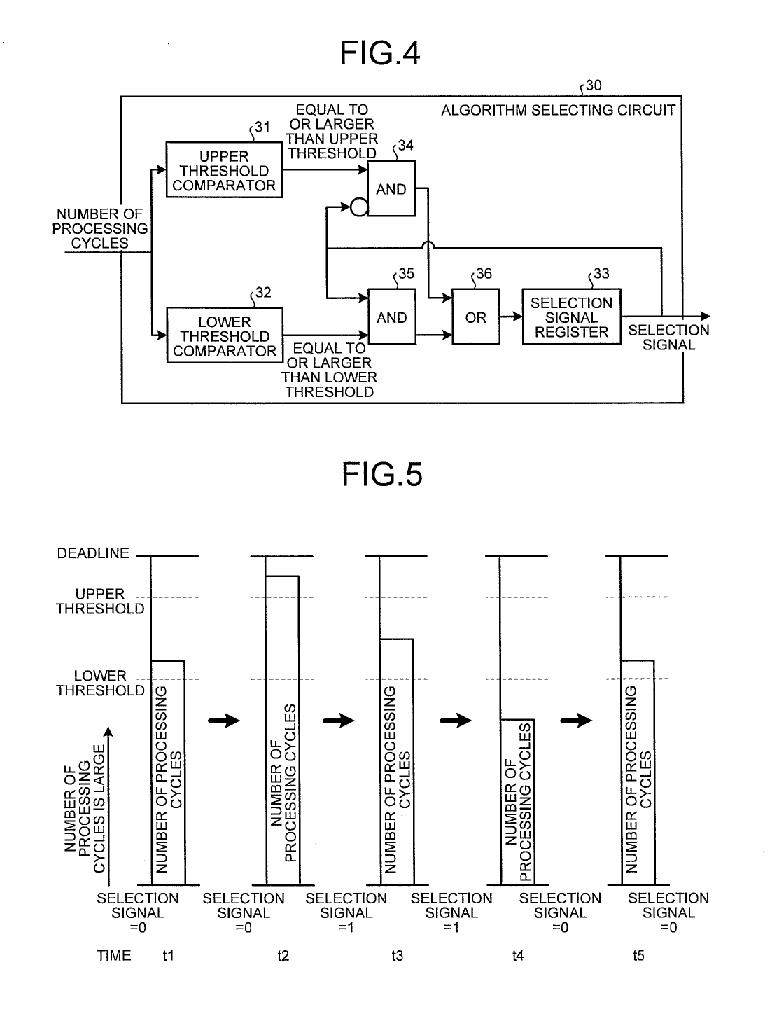

FIG. 4 illustrates a configuration of the algorithm selecting circuit 30.

The algorithm selecting circuit 30 includes an upper threshold comparator 31, a lower threshold comparator 32, a selection signal register 33, a first AND circuit 34, a second AND circuit 35, and an OR circuit 36. When the input number of the processing cycles is equal to or larger than an upper threshold, the upper threshold comparator 31 outputs the value “1”. When the input number of the processing cycles is equal to or larger than a lower threshold, the lower threshold comparator 32 outputs the value “1”. The output from the upper threshold comparator 31 is input to the first AND circuit 34. The value of the selection signal register 33 is inverted and input to the first AND circuit 34, and the first AND circuit 34 outputs a result of an AND operation with the output of the upper threshold comparator 31 to the OR circuit 36. On the other hand, the output of the lower threshold comparator 32 is input to the second AND circuit 35. The value of the selection signal register 33 is input to the second AND circuit 35, and the second AND circuit 35 outputs a result of the AND operation with the output of the lower threshold comparator 32 to the OR circuit 36. The OR circuit 36 outputs a result of an OR operation of the output of the first AND circuit 34 and the output of the second AND circuit 35 to the selection signal register 33. The value of the selection signal register 33 is output to the selectors 13 and 23 as the selection signal. The selection signal sent to the selectors 13 and 23 causes the selectors 13 and 23 to select the first compressor 11 and the first decompressor 21 when the selection signal is “0” and causes the selectors 13 and 23 to select the second compressor 12 and the second decompressor 22 when the selection signal is “1”.

Typically, the upper threshold is set to a value so that the number of the processing cycles is equal to or lower than the upper threshold even if the first compressor 11 and the first decompressor 21 with low processing throughput are used. If the number of the processing cycles input from the data processing module 2 exceeds the upper threshold, the number of the processing cycles may exceed the deadline. The lower threshold is a value that is smaller than the upper threshold and is set such that even if switched to use the compressor and the decompressor (the first compressor 11 and the first decompressor 21) with low throughput when the value smaller than the lower threshold is input from the data processing module as the number of the processing cycles, the number of the processing cycles does not reach the upper threshold immediately.

Next, the operation of the data compression and decompression apparatus 1 is explained.

Write data from the data processing module 2 to the bus 3 is 8-bit image data per pixel and is input to the compression unit 10 with the throughput of eight pixels (64 bits)/cycle in units of 8×8-pixel data block from the data processing module 2.

In the compression unit 10, the first compressor 11 and the second compressor 12 start the compression of the data block as the compression target simultaneously. The selector 13 selects one of the outputs from the first compressor 11 and the second compressor 12 in accordance with the selection signal output from the algorithm selecting circuit 30, and only one of the outputs is sent to the bus 3. The throughput of the bus 3 is higher than the output throughput (throughput of compressor×compression rate) of the compressed data of the first compressor 11 and the second compressor 12, so that the output of the data processing module 2 is not restricted due to the bus 3.

When reading out data from the external memory 4 to the data processing module 2, the data read out from the external memory 4 at 64 bits/cycle is input to the decompression unit 20 via the bus 3. In the decompression unit 20, the first decompressor 21 and the second decompressor 22 start the decompression of the compressed data simultaneously. The selector 23 selects one of the outputs from the first decompressor 21 and the second decompressor 22 in accordance with the selection signal output from the algorithm selecting circuit 30, and only one of the outputs is sent to the data processing module 2.

The initial value of the selection signal register 33 is “0”, and the first compressor 11 and the first decompressor 21 are selected. The number of the processing cycles is sent from the data processing module when the processing for one frame is completed in the moving image processing. In the next frame, the compressed data on the previous frame stored in the external memory 4 is overwritten without being read out. In other words, in the decompression processing of the compressed data on a certain frame, the compressed data on the previous frame is not used.

When the number of the processing cycles is input from the data processing module 2 to the algorithm selecting circuit 30, the magnitude comparison with the upper threshold and the lower threshold is performed in the upper threshold comparator 31 and the lower threshold comparator 32.

When the number of the processing cycles exceeds the upper threshold in the state where the selection signal register 33 is “0”, the value “1” is output from both of the upper threshold comparator 31 and the lower threshold comparator 32. Consequently, the value “1” is output from the first AND circuit 34 and the value “0” is output from the second AND circuit 35, so that the value “1” is output from the OR circuit 36 and the selection signal register 33 is updated to “1”. Consequently, the compressor and the decompressor to be selected are changed to the second compressor 12 and the second decompressor 22 with high throughput, enabling to suppress the number of the processing cycles required for the compression and decompression to low although the image degradation becomes large.

On the other hand, when the number of the processing cycles falls below the lower threshold in the state where the selection signal register 33 is “1”, the value “0” is output from both of the upper threshold comparator 31 and the lower threshold comparator 32. Consequently, the value “0” is output from both of the first AND circuit 34 and the second AND circuit 35, so that the value “0” is output from the OR circuit 36 and the selection signal register 33 is updated to “0”. Consequently, the compressor and the decompressor to be selected are changed to the first compressor 11 and the first decompressor 21 with small compression loss, enabling to suppress the image degradation although the number of the processing cycles becomes large.

FIG. 5 illustrates an example of a change in the number of the processing cycles and an update of the selection signal.

At a time t1, because the number of the processing cycles is smaller than the upper threshold, the value “0” is output from the upper threshold comparator 31 and the value “1” is output from the lower threshold comparator 32. Because the selection signal at the time t1 is “0”, the value “0” is output from both of the first AND circuit 34 and the second AND circuit 35, and the value “0” is output from the OR circuit 36. Therefore, the selection signal register 33 is maintained at “0”.

At a time t2, because the number of the processing cycles exceeds the upper threshold, the value “1” is output from both of the upper threshold comparator 31 and the lower threshold comparator 32. Because the selection signal at the time t2 is “0”, the value “1” is output from the first AND circuit 34 and the value “0” is output from the second AND circuit 35, and the value “1” is output from the OR circuit 36. Therefore, the selection signal register 33 is changed to “1”.

At a time t3, because the number of the processing cycles is larger than the lower threshold, the value “0” is output from the upper threshold comparator 31 and the value “1” is output from the lower threshold comparator 32. Because the selection signal at the time t3 is “1”, the value “0” is output from the first AND circuit 34 and the value “1” is output from the second AND circuit 35, and the value “1” is output from the OR circuit 36. Therefore, the selection signal register 33 is maintained at “1”.

At a time t4, because the number of the processing cycles falls below the lower threshold, the value “0” is output from both of the upper threshold comparator 31 and the lower threshold comparator 32. Because the selection signal at the time t4 is “1”, the value “0” is output from both of the first AND circuit 34 and the second AND circuit 35, and the value “0” is output from the OR circuit 36. Therefore, the selection signal register 33 is changed to “0”.

At a time t5, because the number of the processing cycles exceeds the lower threshold, the value “0” is output from the upper threshold comparator 31 and the value “1” is output from the lower threshold comparator 32. Because the selection signal at the time t5 is “0”, the value “0” is output from both of the first AND circuit 34 and the second AND circuit 35, and the value “0” is output from the OR circuit 36. Therefore, the selection signal register 33 is maintained at “0”.

When the selection signal register 33 becomes “0” at the time t4, the first compressor 11 and the first decompressor 21 with low processing throughput are used, so that the number of the processing cycles becomes large. However, the number of the processing cycles at the time t5 does not exceed the upper threshold, so that the selection signal is maintained at “0”.

The data compression and decompression apparatus according to the present embodiment performs the compression and decompression processing by using the compression and decompression algorithm with low throughput and small compression loss at the normal time. However, when the number of the processing cycles in the image processing system becomes larger than the upper threshold, the data compression and decompression apparatus switches to the compression and decompression algorithm with high throughput and large compression loss to reduce the number of the processing cycles in the compression and decompression processing, thereby contributing to the reduction of the number of the processing cycles in the image processing system. In this state, when the number of the processing cycles in the image processing system becomes smaller than the lower threshold, the compression and decompression algorithm is returned to the normal compression and decompression algorithm to prioritize the small compression loss. Therefore, according to the data compression and decompression apparatus in the present embodiment, when the process performance of the whole image processing system may become low because of the low throughput and the latency in the compression and decompression, or when the number of the processing cycles may exceed the number of deadline cycles in the processing, the high throughput can be secured in exchange for the degradation of data to maintain the process performance of the whole image processing system and to prevent the number of the processing cycles from exceeding the number of deadline cycles.

Moreover, because the compression and decompression algorithm is switched in units of time (frame), an information bit for switching the algorithm does not need to be added to the compressed data.

If the number of the processing cycles rapidly becomes large in one frame, the number of the processing cycles may exceed the deadline before switching to the compression and decompression algorithm with high throughput. However, when processing a moving image, the number of the processing cycles required for processing the adjacent frames is typically in the similar level, so that the possibility that the number of the processing cycles rapidly changes in one frame is low. Therefore, the possibility of exceeding the number of deadline cycles can be reduced by performing the switching control in the present embodiment.

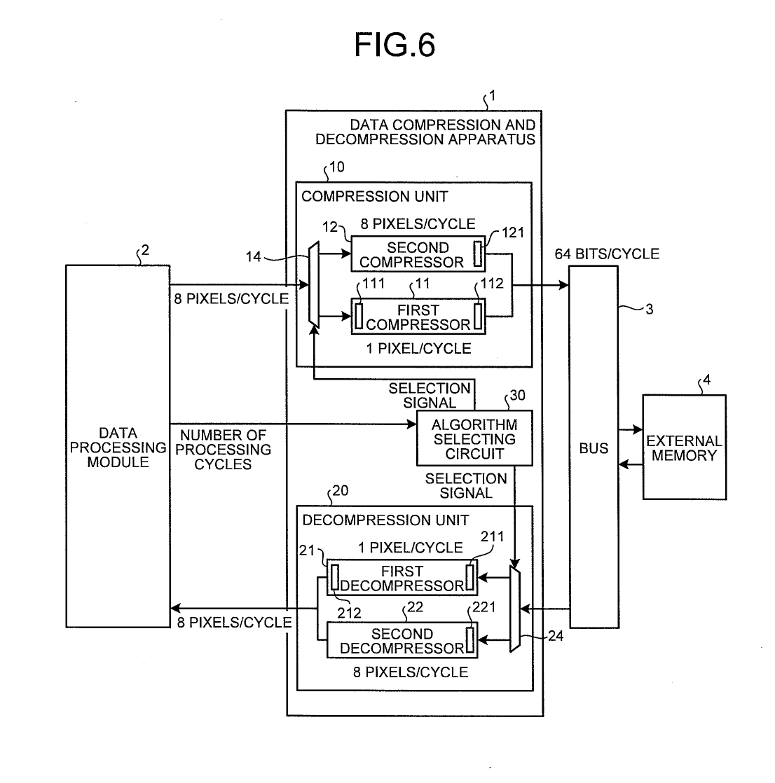

FIG. 6 is a diagram illustrating a configuration of a data compression and decompression apparatus according to a second embodiment of the present invention. In the similar manner to the first embodiment, the data compression and decompression apparatus 1 includes the compression unit 10, the decompression unit 20, and the algorithm selecting circuit 30. The data compression and decompression apparatus 1 is connected to the data processing module 2 and the bus 3 and is further connected to the external memory 4 via the bus 3.

The compression unit 10 is different from that in the first embodiment in points that the selector 13 is not provided and a demultiplexer 14 is arranged on the upstream side (on the side of the data processing module 2) of the first compressor 11 and the second compressor 12.

The decompression unit 20 is different from that in the first embodiment in points that the selector 23 is not provided and a demultiplexer 24 is arranged on the upstream side (on the side of the bus 3) of the first decompressor 21 and the second decompressor 22.

The algorithm selecting circuit 30 is similar to that in the first embodiment. However, the selection signal is output to the demultiplexers 14 and 24.

In the present embodiment, write data from the data processing module 2 to the external memory 4 is input to only one of the first compressor 11 and the second compressor 12 based on the selection signal output from the algorithm selecting circuit 30. Moreover, the compressed data from the external memory 4 to the data processing module 2 is input to only one of the first decompressor 21 and the second decompressor 22. Therefore, the power consumption can be reduced through suppression of the operation of the circuit by keeping the input value to one of the first and second compressors 11 and 12 and to one of the first and second decompressors 21 and 22 (the one to which the write data or the compressed data is not input) constant.

The present embodiment is similar to the first embodiment in other points, so that overlapping explanation is omitted.

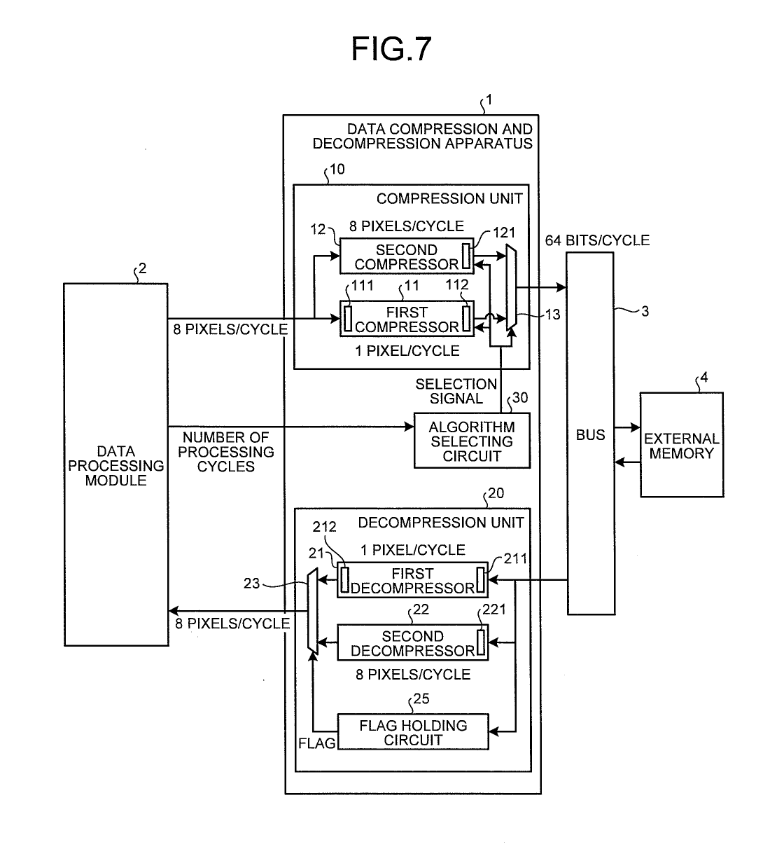

FIG. 7 is a diagram illustrating a configuration of a data compression and decompression apparatus according to a third embodiment of the present invention. The data compression and decompression apparatus according to the present embodiment is different from that in the first embodiment in points that the decompression unit 20 further includes a flag holding circuit 25 and the selection signal output from the algorithm selecting circuit 30 is input to only the compression unit 10. Moreover, the selection signal is input also to the first compressor 11 and the second compressor 12 in the compression unit 10 to be used for adding a flag as will be described later. The data transfer rate and the processing unit are similar to those in the first embodiment.

The first compressor 11 holds the value of the selection signal as a flag at the time of generating the header, so that the header length to be added to the compressed data is one bit longer than that in the first embodiment. However, the compressed data itself is similar to that in the first embodiment.

The second compressor 12 holds the value of the selection signal at the beginning of the compressed data of the data block as the flag, so that the compressed data on a pixel at the beginning of the data block is one bit shorter than the compressed data on remaining pixels. In other words, only the pixel at the beginning of the data block is more compressed than the remaining pixels by one bit which is replaced by the flag. Specifically, when the pixels other than the pixel at the beginning of the data block are compressed to 4 bits, only the pixel at the beginning of the data block is compressed to 3 bits, and the flag is allocated to the remaining one bit. As an example of a method of compressing the pixel at the beginning of the data block more than other pixels by one bit, a method of applying a compression algorithm same as that applied to the pixels other than the pixel at the beginning of the data block to the pixel at the beginning of the data block to compress into the same bit length and truncating the lowest bit can be raised; however, it is not limited to this method.

When reading out data from the external memory 4 to the data processing module 2, the data read out from the external memory 4 at 64 bits/cycle is input to both of the first decompressor 21 and the second decompressor 22 via the bus 3 and the first decompressor 21 and the second decompressor 22 start the decompression processing simultaneously.

The compressed data of which header length is one bit longer than that in the first embodiment is input to the first decompressor 21; however, because the decompression processing is performed disregarding the held flag (value of the selection signal), the decompressed data to be output is the same as that in the first embodiment.

The second decompressor 22 is the same as that in the first embodiment except that the second decompressor 22 deals with that the compressed data on the pixel at the beginning of the data block becomes one bit shorter for the held selection signal, and the decompression processing is performed disregarding the held flag (value of the selection signal). As an example of a method of dealing with the compressed data on the pixel at the beginning of the data block of which bit length is one bit shorter, a method of aligning the bit length of the pixel at the beginning of the data block to that of other pixels by adding 0 or 1 to the lower position of the compressed data and applying the same decompression algorithm for decompressing the compressed data is raised; however, it is not limited this method.

The flag held for each data block is held in the flag holding circuit 25 until the decompression processing of the data block is completed, and is sent to the selector 23 for selecting one of the outputs of the first decompressor 21 and the second decompressor 22 to be sent to the data processing module 2. The flag holding circuit 25 can be configured by using a known lath circuit, so that the detailed explanation of the circuit configuration is omitted.

The configuration and the operation of the algorithm selecting circuit 30 are similar to those of the first embodiment. In the first embodiment, the number of the processing cycles is input from the data processing module 2 when the processing for one frame is completed; however, in the present embodiment, the number of the processing cycles can input in a smaller segment (e.g., in units of data block).

The flag is added to each data block, so that the processing is not failed even when the compression or the decompression is performed over the period before and after changing the value of the selection signal, so that control can be performed in smaller units with a unit of data block defined as a minimum. Moreover, it is possible to decompress the compressed data generated in the previous frame in the next frame and use it.

According to the data compression and decompression apparatus in the present embodiment, when the process performance of the whole image processing system may become low because of the low throughput and the latency in the compression and decompression, or when the number of the processing cycles may exceed the number of deadline cycles in the processing, the high throughput can be secured in exchange for the degradation of data to maintain the process performance of the whole image processing system and to prevent the number of the processing cycles from exceeding the number of deadline cycles.

Each of the above embodiments is an example of embodiments of the present invention, and therefore the present invention is not limited thereto.

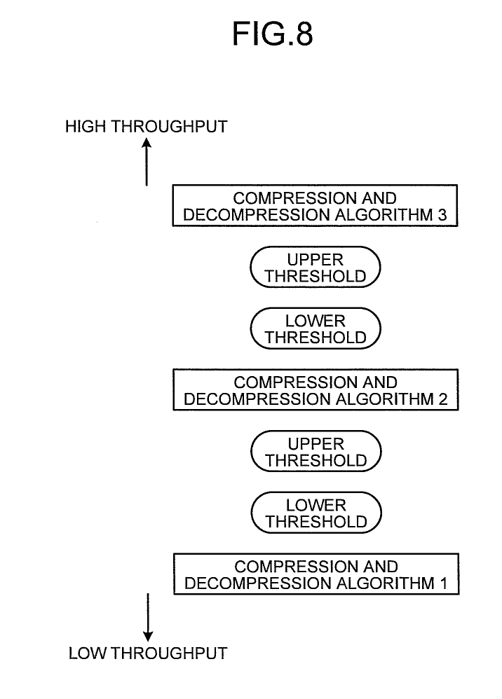

For example, in each of the above embodiments, an example is given for the configuration in which two compression and decompression algorithms are switched to be used; however, the configuration can be such that three or more compression and decompression algorithms are switched to be used. In this case, as shown in FIG. 8, the upper and lower thresholds can be set to each pair of compression and decompression algorithms that are adjacent in the order of the compression and decompression algorithms based on the throughput, and the number of the processing cycles input from the data processing module can be compared with these thresholds to switch the compressor and the decompressor.

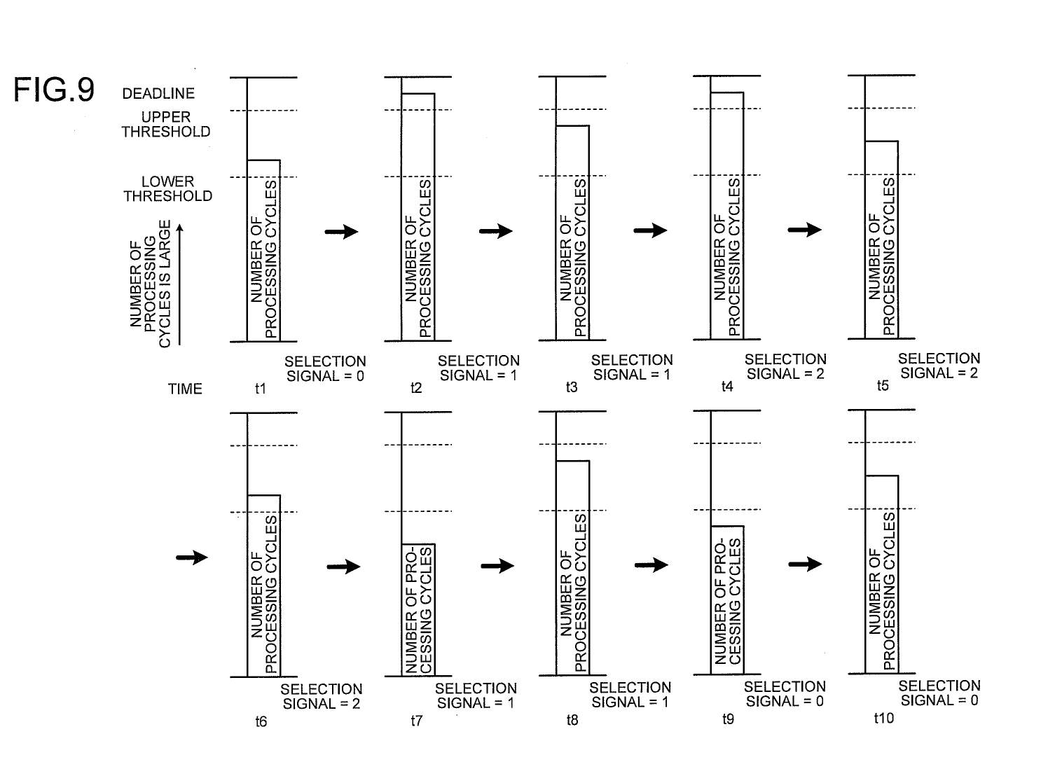

FIG. 9 illustrates an example of a change in the number of the processing cycles and an update of the selection signal in the configuration in which three compression and decompression algorithms are switched. The selection signal “0” indicates that a compression and decompression algorithm 1 with the smallest compression loss and the lowest throughput is selected from among the three compression and decompression algorithms. The selection signal “2” indicates that a compression and decompression algorithm 3 with the largest compression loss and the highest throughput is selected from among the three compression and decompression algorithms. The selection signal “1” indicates that a compression and decompression algorithm 2 with which the compression loss and the throughput are between those in the compression and decompression algorithm 1 and the compression and decompression algorithm 3.

At a time t1, because the number of the processing cycles is smaller than the upper threshold, the selection signal at the time t1 is “0”. At a time t2, because the number of the processing cycles exceeds the upper threshold, the selection signal is changed to “1”. At a time t3, the number of the processing cycles falls below the upper threshold but is larger than the lower threshold, so that the selection signal is maintained at “1”. At a time t4, because the number of the processing cycles exceeds the upper threshold again, the selection signal is changed to “2”. At times t5 and t6, the number of the processing cycles falls below the upper threshold but is larger than the lower threshold, so that the selection signal is maintained at “2”. At a time t7, because the number of the processing cycles falls below the lower threshold, the selection signal is changed to “1”. At a time t8, the number of the processing cycles exceeds the lower threshold but is smaller than the upper threshold, so that the selection signal is maintained at “1”. At a time t9, because the number of the processing cycles falls below the lower threshold again, the selection signal is changed to “0”. At a time t10, the number of the processing cycles exceeds the lower threshold but is smaller than the upper threshold, so that the selection signal is maintained at “0”.

Moreover, in each of the above embodiments, explanation is given for an example in which the processing target is a moving image; however, the processing is not necessarily limited to that with respect to moving image data, and data other than a moving image can be applied for the compression and decompression.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data compression and decompression apparatus configured to compress write data from a data processor and to store the compressed data in an external memory, and to decompress the compressed data from the external memory and to output the decompressed data to the data processor, the data compression and decompression apparatus comprising:
a plurality of compressors configured to execute compression algorithms with same compression rate and different throughputs;
a plurality of decompressors configured to execute decompression algorithms corresponding to the compression algorithms of the compressors, respectively; and
an algorithm switch configured to switch a compressor to be used for compression of the write data and a decompressor to be used for decompression of the compressed data according to a progress in the data processor.

2. The data compression and decompression apparatus of claim 1, wherein the algorithm switch is configured to switch the compressor according to a result of comparison between a threshold with respect to a processing time for a pair of adjacent compressors based on throughputs, and a time for the data processor to generate the write data.

3. The data compression and decompression apparatus of claim 2, wherein a first threshold for switching from a compressor with a high throughput to a compressor with a low throughput and a second threshold for switching from the compressor with a low throughput to the compressor with a high throughput are set to the pair of adjacent compressors based on throughputs as the thresholds with respect to the processing time.

4. The data compression and decompression apparatus of claim 1, wherein
the algorithm switch comprises
an algorithm selector configured to output a selection signal indicative of selection of a compressor to be used for compression of the write data and a decompressor to be used for decompression of the compressed data according to a progress of the data processor,
a compressed data output module configured to output signals from the compressors to the external memory based on the selection signal from the algorithm selector, and
a decompressed data output module configured to output signals from the decompressors to the data processor based on the selection signal from the algorithm selector.

5. The data compression and decompression apparatus of claim 1, wherein
the algorithm switch comprises
an algorithm selector configured to output a selection signal indicative of selecting a compressor to be used for compression of the write data and a decompressor to be used for decompression of the compressed data according to a progress the data processor,
a write data input module configured to input the write data to the selected compressor based on the selection signal, and
a compressed data input module configured to input the compressed data to the selected decompressor based on the selection signal.

6. The data compression and decompression apparatus of claim 5, wherein the write data input module is configured to maintain a constant input value to a compressor which is not selected to receive the write data.

7. The data compression and decompression apparatus of claim 5, wherein the compressed data input module is configured to maintain a constant input value to a decompressor which is not selected to receive the compressed data.

8. The data compression and decompression apparatus of claim 5, wherein
the write data input module is configured to maintain a constant input value to a compressor which is not selected to receive the write data, and
the compressed data input module is configured to maintain a constant input value to a decompressor which is not selected to receive the compressed data.

9. The data compression and decompression apparatus of claim 1, wherein the algorithm switch is configured to switch between the compressor and the decompressor per time unit.

10. The data compression and decompression apparatus of claim 1, wherein
each compressor comprises an adder configured to add an identifier corresponding to each compressor to the compressed data for each data block, and
the algorithm switch comprises
a compressor switch configured to switch the compressor according to a progress of the data processor, and
a decompressor switch configured to switch the decompressor based on the identifier at a time of compression of the write data.

11. The data compression and decompression apparatus of claim 10, wherein
the compressor switch comprises
a compression algorithm selector configured to output a selection signal indicative of selection of a compressor to be used for compression of the write data according to a progress of the data processor, and
a compressed data output module configured to output signals from the compressors to the external memory based on the selection signal from the compression algorithm selector.

12. The data compression and decompression apparatus of claim 11, wherein
the decompressor switch comprises
an identifier extracting module configured to extract the identifier added to the compressed data from the external memory,
an identifier storage module configured to store the identifier, and
a decompressed data output module configured to output signals from the decompressors to the data processor based on the stored identifier.

13. The data compression and decompression apparatus of claim 10, wherein
the compressors are first and second compressors, the first compressor is configured to execute a compression algorithm using a variable-length coding using correlation between adjacent data compression segments, and the second compressor is configured to execute a compression algorithm using a fixed-length coding without correlation between the adjacent data compression segments, and
the second compressor is configured to replace a free bit with the identifier, the free bit being generated by compressing write data at a beginning of a data block into data with a bit length shorter than write data that is not at the beginning of the data block.

14. The data compression and decompression apparatus of claim 13, wherein the compressor configured to execute the compression algorithm using the variable-length coding is configured to add a header comprising the identifier to be referred to by the decompressor at a time of decompression of the compressed data by the data block.

15. The data compression and decompression apparatus of claim 1, wherein
the compression modules are first and second compressors,
the first compressor is configured to implement a compression algorithm using a variable-length coding using correlation between adjacent data compression segments, and
the second compressor is configured to execute a compression algorithm using a fixed-length coding without correlation between the adjacent data compression segments.

16. The data compression and decompression apparatus of claim 15, wherein the compressor configured to execute the compression algorithm using the variable-length coding is configured to add a header to be referred to by the decompression module at a time of decompression of the compressed data by the data block.

17. A data compression and decompression method of compressing write data from a data processor and storing the compressed data in an external memory, and decompressing compressed data from the external memory and outputting the decompressed data to the data processor, the data compression and decompression method comprising:
switching a compressor to be used for compression of the write data and a decompressor to be used for decompression of the compressed data between a plurality of compressors configured to execute compression algorithms with same compression rate and different throughputs and a plurality of decompressors configured to execute decompression algorithms corresponding to the compression algorithms of the compressors, respectively, according to a progress of the data processor.

18. The data compression and decompression method of claim 17, further comprising switching the compressor according to a result of comparison between a threshold with respect to a processing time for a pair of adjacent compressors based on throughputs, and a time for the data processor to generate the write data.

19. The data compression and decompression method of claim 18, further comprising setting a first threshold for switching from a compressor with a high throughput to a compressor with a low throughput and a second threshold for switching from the compressor with a low throughput to the compressor with a high throughput to the pair of adjacent compressors based on throughputs as the thresholds with respect to the processing time.

20. The data compression and decompression method of claim 17, further comprising switching the compressor and the decompressor per time unit.
